(19) United States
(12) Patent Application Publication
(10) Pub. No.: US 2003/0136603 A1
(43) Pub. Date: Jul. 24, 2003

(54) Parghi ergomobile

(76) Inventor: Kaumil H. Parghi, Tempe, AZ (US)

Correspondence Address: KAUMIL H. PARGHI, 950 S. TERRACE ROAD, # D280, TEMPE, AZ, 85281, US

(21) Appl. No.: 10/051,148

(22) Filed: Jan. 22, 2002

(51) Int. Cl. B60K 26/00

(52) U.S. Cl. 180/315

(57) ABSTRACT

Automobiles today are provided with one right-foot accelerator located near and in front of the right foot of the driver, and a brake located left of the accelerator. Both, the accelerator and the brake are located such that they can only be comfortably used by the right foot. My invention, the ‘Parghi Ergomobile’ now provides for automobiles with two accelerators, the right-foot one that is located such that it is in front of and near the right foot and the left-foot one that is located such that it is in front of and near the left foot with one brake pedal located in the center. When the driver is tired of accelerating with the right foot, he/she can start accelerating with the left one and vice versa. Or he/she can accelerate with both the feet if they chose so. Using both legs or switching legs while driving will reduce injuries caused by repetitive motion on the right leg.

### CROSS-REFERENCE TO RELATED APPLICATIONS

1. The Ergonomic Office

Office desks, furniture, and appliances nowadays are designed such as to prevent injuries to the body due to repetitive motions performed by employees in everyday jobs.

2. The Ergonomic Home

Chairs, beds, and pillows are nowadays designed to prevent posture injuries to the body while sitting or sleeping

### STATEMENT RE: FEDERALLY SPONSORED RESEARCH OR DEVELOPMENT

Not Applicable

### REFERENCE TO A MIRCROFICHE APPENDIX

Not Applicable

### BACKGROUND OF THE INVENTION

For years, domestic and professional drivers have been driving on the road carelessly and without much thought to injuries on their right leg caused due to repetitive motion of driving. After years of driving they realize that they experience pain in their right leg, the hip joint, the knee, and the foot, which was caused by lifting the leg and pushing the accelerator and brake constantly everyday using the right leg. Time has now come to equalize the stress of driving on both, the right and the left leg, thus reducing the injury to the right leg by half.

### SUMMARY OF THE INVENTION

The ‘PARGHI ERGOMOBILE’ is a simple invention that equalizes the use of both, the right and the left foot while driving an automobile by providing two accelerators, the left-foot accelerator and the right-foot accelerator, instead of just one, the right-foot accelerator that is provided in automobiles today.

### DESCRIPTION OF THE INVENTION

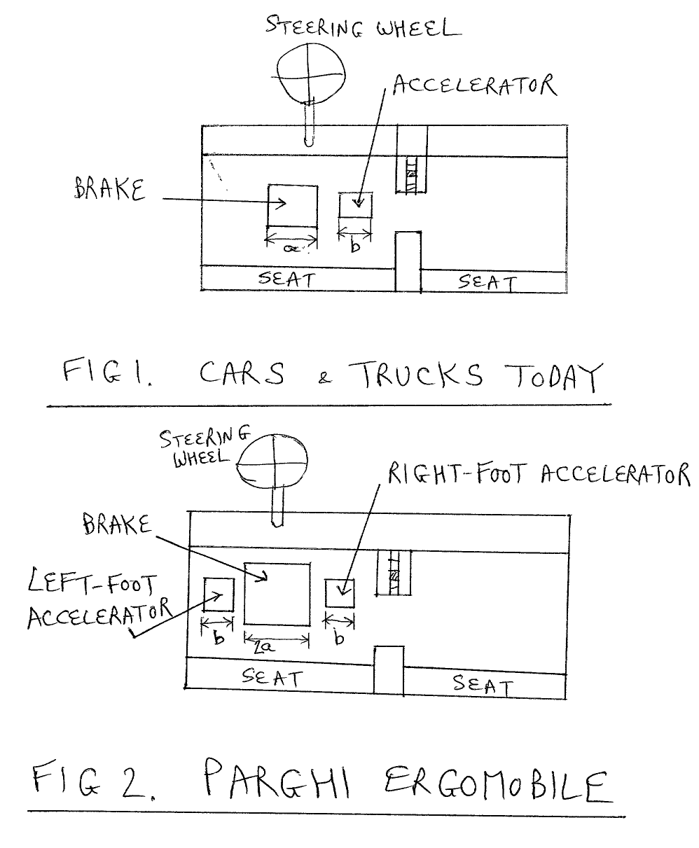

Automobiles today are provided with one right-foot accelerator located near and in front of the right foot of the driver, and a brake in the right-center. Both, the accelerator and the brake are located such that they can only be comfortably used by the right foot. See FIG. 1.

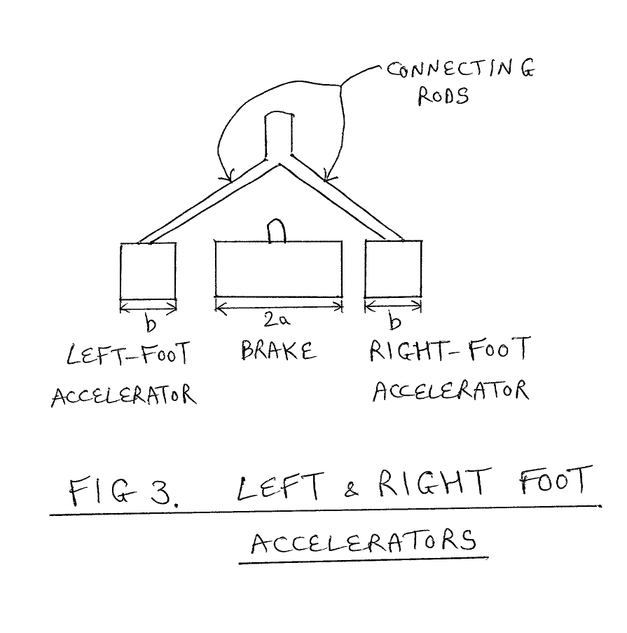

My invention titled ‘Parghi Ergomobile’ now provides for automobiles with two accelerators, the right-foot one that is located such that it is in front of and near the right foot and the left-foot one that is located such that it is in front of and near the left foot, with one brake pedal located in the center. When the driver is tired of accelerating with the right foot, he/she can start accelerating with the left one and vice versa. Or he/she can accelerate with both the feet if they chose so. See FIG. 2. I am naming this invention as the ‘Parghi Ergomobile’, after my last name, ‘Parghi’.

1. I claim that providing for and utilizing two accelerators, the right-foot accelerator and the left-foot accelerator in automobiles will equalize the stress in both the legs in the body of the driver, thereby, reducing injuries caused due to repetitive motion of driving, on the right leg, by half. Also, using two legs while driving will reduce the stress of the driver by enabling him to either switch the use of legs during acceleration or accelerate using both legs.
